(19) United States
(12) Patent Application Publication
(10) Pub. No.: US 2009/0001887 A1
(43) Pub. Date: Jan. 1, 2009

(54) Metal Halide Lamp and Lighting Unit Utilizing the Same

(76) Inventors: Nobuyoshi Takeuchi, Osaka (JP); Atsushi Utsubo, Osaka (JP); Yukiya Kanazawa, Osaka (JP)

Correspondence Address: SNELL & WILMER L.L.P. (Panasonic), 600 ANTON BOULEVARD, SUITE 1400, COSTA MESA, CA, 92626, US

(21) Appl. No.: 11/814,439

(22) PCT Filed: Jan. 11, 2006
(86) PCT No.: PCT/JP2006/300201

§ 371 Date: Jul. 20, 2007

(30) Foreign Application Priority Data
Jan. 25, 2005 (JP) 2005-016478

(51) Int. Cl. H01J 61/18

(52) U.S. Cl. 313/638

(57) ABSTRACT

An arc tube (6) of a metal halide lamp (1) has a ceramic envelope (10), a pair of electrodes (16), and metal halides enclosed therein. The arc tube (6) satisfies the relationship EL/Di>4.0, where EL represents the distance between the pair of electrodes (16) in mm, Dᵢ represents the maximum inside diameter of the arc tube (6) measured in mm at a portion positionally corresponding to the gap between the pair of electrodes (16). In addition, the metal halides enclosed within the arc tube (6) include at least sodium halide and neodymium halide. With this configuration, the metal halide lamp (1) achieves an improved emission color characteristic, while maintaining high lamp efficiency.

### TECHNICAL FIELD

The present invention relates to a metal halide lamp and also to a lighting unit using the metal halide lamp.

### BACKGROUND ART

Metal halide lamps, especially those having a ceramic envelope enclosing an arc tube (hereinafter, simply “ceramic metal halide lamps”), are known for favorable characteristics, such as high efficiency and good color rendition. For this reason, such metal halide lamps are widely used for general illumination purposes at stores and other settings.

In order to achieve energy savings, it is recently demanded for such ceramic metal halide lamps to further improve efficiency (for example 120 lm/W or higher).

Some conventional attempts have been made to improve efficiency of a lamp of the kind for general illumination purposes. One example is to use an arc tube that is filled with cerium iodide (CeI₃) and sodium iodide (NaI). In addition, the arc tube has a long and thin shape (satisfying the relationship EA/Dᵢ>5, where Dᵢ represents the inside diameter of the arc tube and EA represents the distance between electrodes). (See, for example, Patent Document 1 listed below.)

Another example is to use an arc tube that is filled with praseodymium iodide (PrI₃) and sodium iodide (NaI). The arc tube in this example also has a long and thin shape (satisfying the relationship L/D>4, where D represents the inside diameter of the arc tube and L represents the distance between electrodes) (See, for example, Patent Document 2 listed below.)

### [Patent Document 1]

JP Patent Application Publication No. 2000-501563

### [Patent Document 2]

JP Patent Application Publication No. 2003-229089

### DISCLOSURE OF THE INVENTION

### Problems the Invention is Attempting to Solve

The inventors of the present invention prepared ceramic metal halide lamps according to Patent Documents 1 and 2 listed above and evaluated their lamp efficiencies and emission color characteristics. The evaluation results show that the conventional ceramic metal halide lamps achieve high lamp efficiency. However, the evaluation results also show a disadvantage that Duv (Deviation from Planckian locus multiplied by 1,000) parameters are notably high, which means that the conventional ceramic metal halide lamps fail to emit light of a desirable color (white light) for general illumination purposes.

The present invention is made in view of the above problems and aims to improve the color characteristics of a lamp without compromising the high efficiency.

### Means for Solving the Problems

According to one aspect the present invention, a metal halide lamp includes an arc tube having: a ceramic envelope; a pair of electrodes; and metal halides enclosed therein. The arc tube satisfies the relationship EL/Dᵢ>4.0, where EL represents a distance between the pair of electrodes measured in millimeters, and Dᵢ represents a maximum inside diameter of the arc tube measured in millimeters at a portion positionally corresponding to a gap between the pair of electrodes. The metal halides include at least sodium halide and neodymium halide.

According to another aspect of the present invention, a lighting unit includes: a metal halide lamp as defined above; a ballast for operating the metal halide lamp; and a lighting fixture having the metal halide lamp incorporated therein.

### Effects of the Invention

The present invention aims to provide a metal halide lamp with improved emission color characteristics, while maintaining high efficiency. The present invention also aims to provide a lighting unit utilizing the metal halide lamp.

### BRIEF DESCRIPTION OF THE DRAWINGS

FIG. 1 is a front view, partially broken away, showing a metal halide lamp 1 according to a first embodiment of the present invention;

FIG. 2 is a sectional view of an arc tube used in the metal halide lamp;

FIG. 3 is a graph showing the relationship between lamp efficiency and EL/Dᵢ;

FIG. 4 is a table showing features of metal halide lamps used in tests;

FIG. 5 is a table showing the features of the metal halide lamps used in the tests;

FIG. 6 is a graph of the luminous maintenance factor of Example 1;

FIG. 7 is a graph of the luminous maintenance factor of Example 2;

FIG. 8 is a graph of the luminous maintenance factor of Example 3;

FIG. 9 is a graph of the luminous maintenance factor of Example 4;

FIG. 10 is a graph of the luminous maintenance factor of Example 5;

FIG. 11 is a graph of the luminous maintenance factor of Example 6;

FIG. 12 is a table showing the relationship between M_{Na}/M_{Nd} and lamp efficiency;

FIG. 13 is a graph showing the relationship between M_{Na}/M_{Nd} and lamp efficiency;

FIG. 14 is a table showing the relationship between M_{Na}/(M_{Nd}+M_{Pr}) and lamp efficiency;

FIG. 15 is a graph showing the relationship between M_{Na}/(M_{Nd}+M_{Pr}) and lamp efficiency; and

FIG. 16 is a schematic view of a lighting unit according to a second embodiment of the present invention.

### REFERENCE NUMERALS

1 Metal Halide Lamp

2 Glass Stem

3 Outer Tube

4,5 Power Feed Lines

6 Arc Tube

7 Base

8 Eyelet Portion

9 Shell Portion

10 Envelope

11 Electrode Assembly

12 Cylindrical Portion

13 Tapered Portion

14 Main Tube

15 Thin Tube

16 Electrode

17 Discharge Space

18 Electrode Rod

19 Electrode Coil

20 Internal Lead

21 External Lead

22 Sealing Member

23 Tubular Member

24 Ceiling

25 Reflector

26 Substrate Part

27 Socket Part

28 Lighting Fixture

29 Electronic Ballast

### BEST MODE FOR CARRYING OUT THE INVENTION

The following describes the best mode of the present invention, with reference to the accompanying drawings.

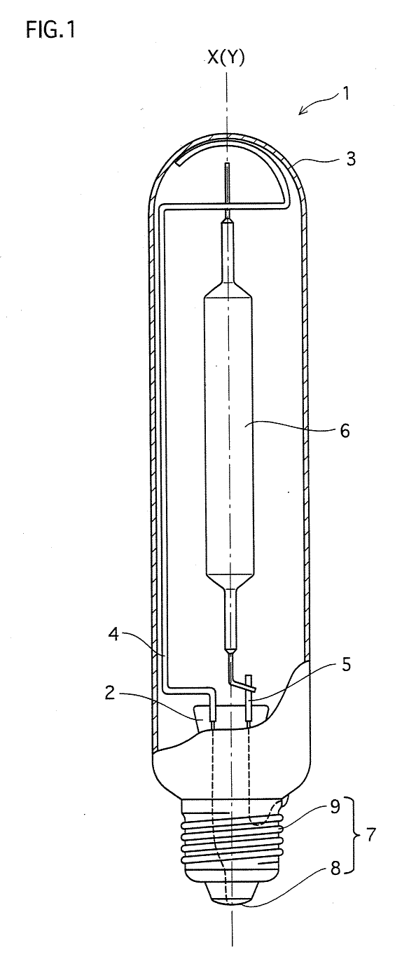

FIG. 1 illustrates a metal halide lamp (ceramic metal halide lamp) 1 according to a first embodiment of the present invention. The rated power (input power) of the metal halide lamp 1 is 200 W. As illustrated, the metal halide lamp 1 includes a glass stem 2, an outer tube 3, a pair of power feed lines 4 and 5, an arc tube 6, and a screw base 7. The outer tube 3 is a straight tube having a closed end and an open end that is sealed with the glass stem 2. The feed lines 4 and 5 are partially sealed within the glass stem 2 in a manner that a first end of each feed line is drawn into the outer tube 3. The arc tube 6 is supported by the power feed lines 4 and 5 so as to be held in place within the outer tube 3. The screw base 7 (E type) is fixed to the open end of the outer tube 3 by screwing.

The central axis X of the outer tube 3 in the longitudinal direction substantially coincides with the central axis Y of the arc tube 6 in the longitudinal direction.

The outer tube 3 is made of, for example, hard glass and is evacuated to create a vacuum of 1×10⁻¹ Pa or so at 300 K.

Note that the shape of the outer tube 3 is not limited to a straight tube as illustrated in FIG. 1. The outer tube 3 may be of any of various other shapes known in the art, including a drop type.

The power feed lines 4 and 5 are made of nickel or mild steel, for example. A second end of the power feed line 4 is electrically connected to an eyelet portion 8 of the base 7. A second end of the power feed line 5 is electrically connected to a shell portion 9 of the base 7.

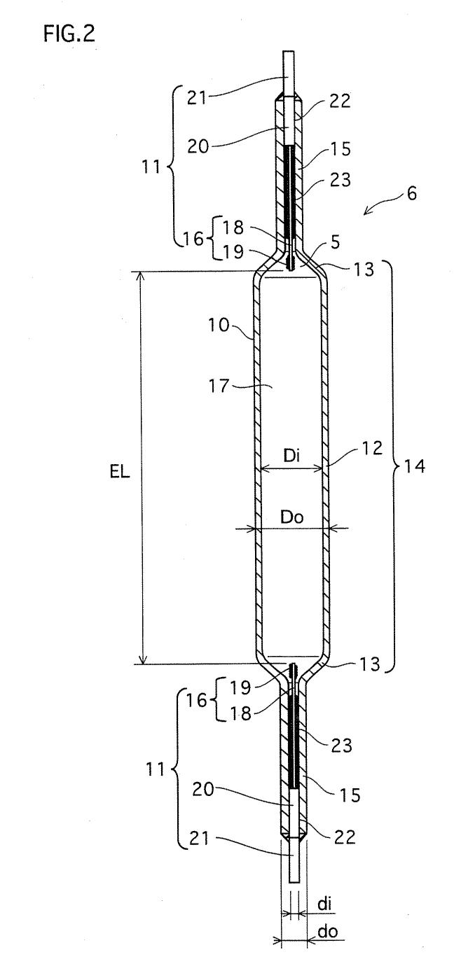

As illustrated in FIG. 2, the arc tube 6 includes an envelope 10 made of translucent polycrystalline alumina (total transmittance: approximately 96%) and a pair of electrode assemblies 11 disposed inside the envelope 10.

The envelope 10 is composed of a main tube 14 and a pair of thin tubes 15 that extend integrally from the opposite ends of the main tube 14. The main tube 14 has a cylindrical portion 12 that is substantially cylindrical in shape and two tapered portions 13 integrally extended from the opposite ends of the cylindrical portion 12. Each thin tube 15 is also substantially cylindrical in shape and has an outside diameter dₒ that is smaller than the maximum outside diameter Dₒ of the main tube 14 (the outside and inside diameters of each thin tube 15 is 3.2 mm and 1.0 mm, respectively).

Note that the envelope 10 is an integral whole composed of the cylindrical portion 12, the tapered portions 13, and the thin tubes 15 that are all formed at the same time. In other words, the envelope 10 is not composed of separately formed pieces that are joined together by shrinkage fitting. The envelope 10 may be made of translucent ceramic instead of polycrystalline alumina. Examples of such translucent ceramic materials include yttrium-aluminum-garnet (YAG), aluminum nitride, yttria, and zirconia.

Furthermore, the arc tube 6 is filled with metal halides each acting as a luminescent material, 0.8 mg of mercury acting as a buffer gas, and 20 Pa of xenon acting as a starting gas. The metal halides filled in the arc tube 6 include at least neodymium halide, such as neodymium iodide (NdI₃), and sodium halide, such as sodium iodide (NaI).

It is especially preferable that the metal halides further include praseodymium halide, such as praseodymium iodide (PrI₃), in addition to neodymium iodide and sodium iodide mentioned above. The presence of praseodymium halide further improves lamp efficiency and suppresses color temperature variability throughout operation of the lamp.

In the case where the metal halides filled in the arc tube 6 are limited to sodium halide and neodymium halide, it is preferable that the following relationship is satisfied for the reason described later:

5≦M_{Na}/M_{Nd}≦21,

where
M_{Na} represents the enclosed amount of sodium halide (in mol), and
M_{Nd} represents the enclosed amount of neodymium halide (in mol).

Furthermore, in the case where the metal halides filled in the arc tube 6 are limited to sodium halide, neodymium halide, and praseodymium halide, it is preferable that the following relationship is satisfied for the reason described later:

4≦M_{Na}/(M_{Nd}+M_{Pr})≦27.5,

where

M_{Pr}/M_{Nd}≦4, and

where
M_{Na} represents the enclosed amount of sodium halide (in mo!),
M_{Nd} represents the enclosed amount of neodymium halide (in mol), and
M_{Pr} represents the enclosed amount of praseodymium halide (in mol).

Although the above listing is limited to iodides, it is naturally appreciated that one ore more, or possibly all, of the iodides may be replaced with bromides.

As inert gas, an xenon gas and an argon gas may be used singly or in combination as a mixture gas. Irrespective of the components and the ratio thereof, it is preferable to optimize the amount of inert gas contained within a range of 10 to 50 kPa.

The dimensions of the arc tube 6 satisfies the following relationship:

EL/Dᵢ>4.0,

where
EL represents the distance between later-described electrodes 16 (in mm), and
Dᵢ represents the maximum inside diameter (in mm) of the arc tube 6 measured at a portion positionally corresponding to the gap between the electrodes where the distance EL is measured (hereinafter, Dᵢ is referred to simply as “the maximum inside diameter of the arc tube”).

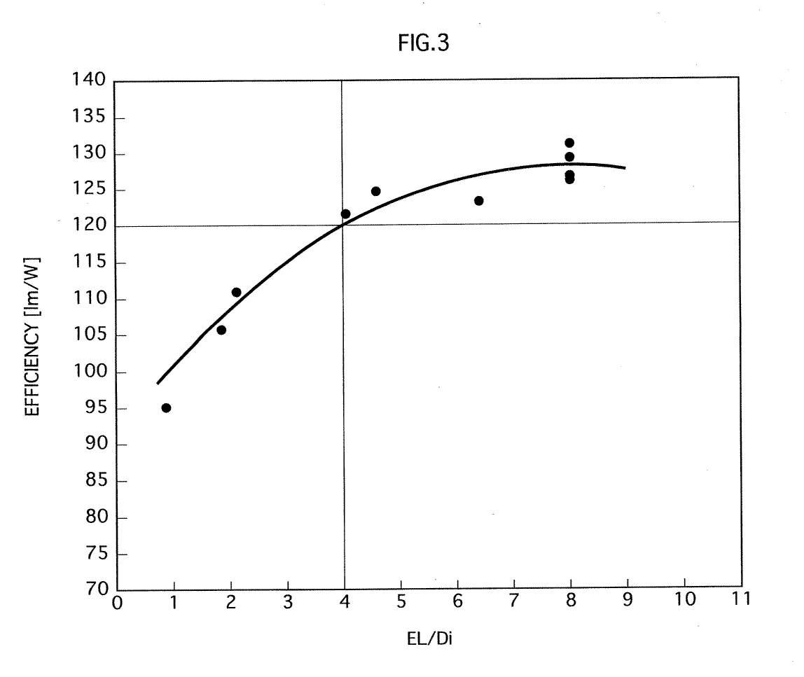

Now, the following describes the reason why the arc tube 4 is designed to satisfy the relationship EL/Dᵢ>4.0. Various samples were made according to the metal halide lamp 1 of the present invention to measure their lamp efficiencies. The measurements are plotted against EL/Dᵢ as illustrated in FIG. 3. As is clear from FIG. 3, the target lamp efficiency (120 lm/W or higher, for example) is achieved when the arc tube dimensions satisfy the relationship EL/Dᵢ>4.0. However, if the distance EL between the electrodes 16 is too long, there is a risk that a discharge occurring between the electrodes 16 would not smoothly shift from a glow phase to an arc phase at the time of lamp startup. During the transition from glow to arc discharge, tungsten constituting the electrodes 16 is sputtered onto the inner surface of the arc tube 6, leading to blackening of the arc tube 6. Arc tube blackening is undesirable because it reduces the total luminous flux and detracts the appearance. In addition, if the lamp starts hard, it is required to raise the starting voltage.

On the other hand, if the maximum inside diameter Dᵢ of the arc tube 6 is too small and thus the distance between arc center and the inner surface of the arc tube 6 is extremely short, there is a risk that recombination of electrons occur to much. As a consequence, discharge may not be maintained so that the lamp goes out.

In view of the above, it is preferable that the distance EL between the electrodes 16 is not too long and the maximum inside diameter Dᵢ of the arc tube 6 is not too small. Practically, it is preferable to satisfy the relationship EL/Dᵢ≦15. It is further preferable to satisfy the relationship EL/Dᵢ≦10.

In order to further increase the lamp in efficiency and operating life, it is preferable that the wall loading WL (W/cm²) of the arc tube 6 satisfies the relationship 25≦WL≦37. When WL<25, a sufficient wall (coldest spot) temperature cannot be ensured, so that such a lamp would not achieve high efficiency. On the other hand, when WL>37, the arc tube 6 would experience a temperature rise. As a result, the lamp may fade out due to a voltage rise during a life test or the lamp may go out due to generation of clacks before the end of its rated lamp life.

In the example illustrated in FIG. 2, the distance EL between the electrodes 16 measures 40.0 mm, the maximum inside diameter Dᵢ of the arc tube 6 measures 5.0 mm. Thus, EL/Dᵢ=8.0. In addition, the maximum outside diameter Dₒ of the arc tube 6 measures 7.5 mm. Each thin tube 15 measure 3.2 mm in outside diameter dₒ and 1.0 mm in inside diameter dᵢ.

Each electrode assembly 11 measures 6.0 mm in full length and is composed one of the electrodes 16 and internal and external leads 20 and 21. Each electrode 16 is composed of an electrode rod 18 and an electrode coil 19 both made of tungsten. The electrode rod 18 measures, for example, 0.50 mm in outside diameter and 16.5 mm in length. The electrode coil 19 is attached to a first end of the electrode rod 18. The internal lead 20 is made of a conductive cermet, which for example is a sintered mixture of aluminum oxide (Al₂O₃) and molybdenum (Mo) and measures, for example, 0.95 mm in diameter and 3.1 mm in length. The external lead 21 is made, for example, of niobium. A first end of the internal lead 20 is connected to the second end of the electrode rod 18 and a second end of the internal lead 20 is connected to a first end of the external lead 21. A second end of the external lead is electrically connected to both the power feed lines 4 and 5.

Note that a second end of each internal lead 20 is exposed from the thin tube 15.

The electrode assemblies 11 described above are each inserted into the respective thin tubes 15, so that the tip of the electrode 16, i.e., the portion containing the electrode coil 19 is located inside the main tube 14 and that the opposite end of the thin tube 15 from the main tube 14 entirely covers the internal lead 20. In this state, each electrode assembly 11 is sealed to the thin tube 15 with a sealing material 22 poured into the gap formed between the electrode assembly 11 and the thin tube 15. The sealing member 22 is made of grass frit (Dy₂O₃—Al₂O₃—SiO₂ frit) and the length of the frit sealing measures 5.0 mm. Note, however, after the sealing, the sealing material 22 presents not only within the gap between the electrode assembly 11 and the thin tube 15 but also outside the thin tube 15 in a manner to cover the joint between the internal and external leads 20 and 21.

The electrodes 16 are so arranged that the tips thereof are substantially coaxial (on Y axis) and substantially opposed to each other within the main tube 10.

That is, the “distance EL between the electrodes 16” mentioned above refers to the shortest distance between the tips of the opposing electrodes 16. According to the first embodiment, the end of the electrode rod 18 closer to the discharge space 17 extends beyond the electrode coil 19. Thus, the “distance EL between the electrodes 16” refers to the line segment connecting the exposed ends of the electrode rods 18. Note that the direction along which the distance EL between the electrodes 16 extends is substantially orthogonal to the direction of the inside diameter Dᵢ of the arc tube 6.

Ideally, the electrode assemblies 11 are sealed to the thin tube 15 in such a manner that the central axis of the electrode rods 18 in the longitudinal direction coincides with the central axis Y of the arc tube 6 in the longitudinal direction. In this case, the direction of the distance EL between electrodes 16 is completely orthogonal to the direction of the inside diameter Dᵢ of the arc tube 6. In practice, however, the electrode assemblies 11 sealed to the thin tube 15 may be out of exact alignment or inclined. In this case, the direction of the distance EL between the electrodes 16 may be slightly deviated from the complete orthogonal to the direction of the inside diameter Dᵢ. The wording “substantially orthogonal” includes this state within its scope.

As mentioned above, each internal lead 20 is a conductive cermet which is a sintered mixture of aluminum oxide (Al₂O₃) and molybdenum (Mo). Alternatively, however, the internal lead 20 may be a conductive cermet which is a sintered mixture of aluminum oxide (Al₂O₃) and tungsten (W) or any of various halogen resistant materials known in the art may be used. Thus, the internal leads 20 may simply be metal rods made of molybdenum, for example.

In addition, the electrode assemblies 11 composed of the electrode 16 and the internal and external leads 20 and 21 are described by way of example and without limitation. Any of various electrode assemblies known in the art may be used. For example, each electrode assembly may be composed of a single and seamless piece of lead, rather than internal and external leads that are joined together. In this case, one end of the lead is connected to the electrode rod 18 and the other end is exposed from the thin tube 15 and connected to the power feed lines 4 and 5. Since any of various types of electrode assemblies may be used, the sealing may be done by an appropriate known metallizing, instead of using the sealing material 22 described above.

Inside each thin tube 15, a metal tubular member 23 is disposed circumferentially between the thin tube 15 and the electrode assembly 11, more specifically between the thin tube 15 and the electrode rod 18. The tubular member 23 may be a close winding coil made of molybdenum with a gauge of 0.20 mm. Each tubular member 23 is provided to fill the gap present between the thin tube 15 and the electrode rod 18 as much as possible in order to block metal halides from entering into the thin tube 15. Yet, in order to allow for insertion into the thin tube 15 of each electrode assembly 11 to which the tubular member 23, the tubular member 23 needs to be such a size that leaves sufficient clearance between the tubular member 23 and the thin tube 15. According to the first embodiment, a clearance of 0.50 mm is left at average between the thin tube 15 and the tubular member 23.

The metal halide lamp 1 having the above described structure is operated on an exemplary electronic ballast (not illustrated) described below. The electronic ballast applies pulses of 4.0 kV at maximum and at high frequencies in the range of 240 to 390 kHz at the time of lamp startup and re-startup. For steady state operation of the lamp, on the other hand, the electronic ballast applies a rectangular wave at the frequency of 200 Hz.

Next, tests were conducted on the metal halide lamp 1 according to the first embodiment of the present invention to prove the effects.

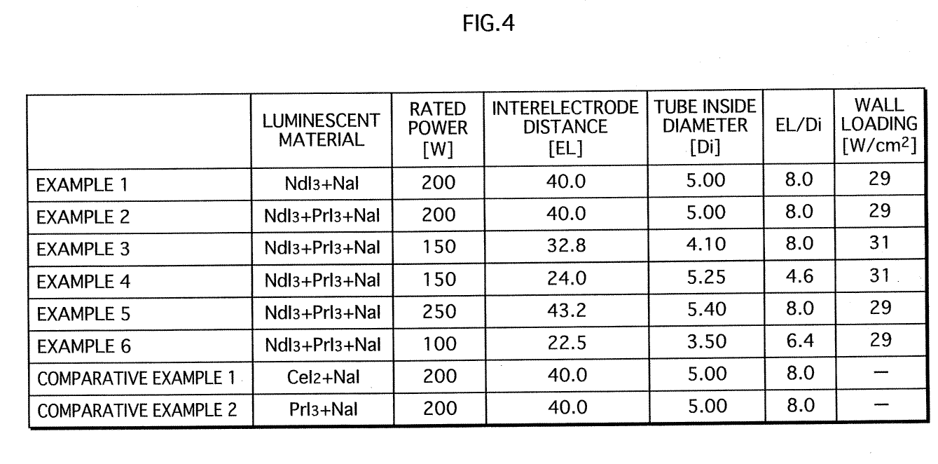

First of all, five samples were prepared for each of Examples 1-6 of the metal halide lamp 1 shown in FIG. 4. Each sample is basically identical in structure to the metal halide lamp 1 as described in the first embodiment. The differences are found in the electrode distance EL, the maximum inside diameter Dᵢ of the arc tube, the kinds and amounts of metal halides acting as luminescent materials, and the amount of mercury acting as buffer gas.

Each metal halide lamp 1 of Example 1 is such that the rated power is 200 W, the distance EL between the electrodes 16 measures 40.0 mm, the maximum inside diameter Dᵢ of the arc tube 6 measures 5.0 mm (outside diameter is 7.5 mm), EL/Dᵢ=8.0, and the wall loading WL measures 29 W/cm². In addition, the arc tube 6 is filled with 4.0 mg of neodymium iodide, 8.0 mg of sodium iodide, and 0.8 mg of mercury.

Each metal halide lamp 1 of Example 2 is such that the rated power is 200 W, the distance EL between the electrodes 16 measures 40.0 mm, the maximum inside diameter Dᵢ of of the arc tube 6 measures 5.0 mm (outside diameter is 7.5 mm), EL/Dᵢ=8.0, and the wall loading WL measures 29W/cm². In addition, the arc tube 6 is filled with 1.0 mg of neodymium iodide, 3.5 mg of praseodymium iodide, 9.0 mg of sodium iodide, and 0.7 mg of mercury.

Each metal halide lamp 1 of Example 3 is such that the rated power is 150 W, the distance EL between the electrodes 16 measures 32.8 mm, the maximum inside diameter Dᵢ of the arc tube 6 measures 4.1 mm (outside diameter is 6.3 mm), EL/Dᵢ=8.0, and the wall loading WL measures 31 W/cm². In addition, the arc tube 6 is filled with 1.0 mg of neodymium iodide, 1.25 mg of praseodymium iodide, 7.75 mg of sodium iodide, and 0.7 mg of mercury.

Each metal halide lamp 1 of Example 4 is such that the rated power is 150 W, the distance EL between the electrodes 16 measures 24.0 mm, the maximum inside diameter Dᵢ of the arc tube 6 measures 5.25 mm (outside diameter is 7.45 mm), EL/Dᵢ=4.6, the wall loading WL measures 31 [W/cm²]. In addition, the arc tube 6 is filled with 1.0 mg of neodymium iodide, 1.5 mg of praseodymium iodide, 7.5 mg of sodium iodide, and 1.9 mg of mercury.

Each metal halide lamp 1 of Example 5 is such that the rated power is 250 W, the distance EL between the electrodes 16 measures 43.2 mm, the maximum inside diameter Dᵢ of the arc tube 6 measures 5.4 mm (outside diameter is 7.8 mm), EL/Dᵢ=8.0, and the wall loading WL measures 29 W/cm². In addition, the arc tube 6 is filled with 1.5 mg of neodymium iodide, 3.0 mg of praseodymium iodide, 10.5 mg of sodium iodide, and 1.0 mg of mercury.

Each metal halide lamp 1 of Example 6 is such that the rated power is 100 W, the distance EL between the electrodes 16 measures 22.5 mm, the maximum inside diameter Dᵢ of the arc tube 6 measures 3.5 mm (outside diameter is 5.5 mm), EL/Dᵢ=6.4, the wall loading WL measures 33 W/cm². In addition, the arc tube 6 is filled with 0.75 mg of neodymium iodide, 1.0 mg of praseodymium iodide, 5.5 mg of sodium iodide, and 0.8 mg of mercury.

Each metal halide lamp 1 of Example 6 is such that the rated power is 100 W, the distance EL between the electrodes 16 measures 22.5 mm, the maximum inside diameter Dᵢ of the arc tube 6 measures 3.5 mm (outside diameter is 5.5 mm), EL/Dᵢ=6.4, the wall loading WL measures 33 W/cm². In addition, the arc tube 6 is filled with 5.5 mg of sodium iodide, 0.75 mg of neodymium iodide, 1.0 mg of praseodymium iodide , and 0.8 mg of mercury.

For the purpose of comparison, five metal halide lamps ware manufactured for each of Comparative Examples illustrated in FIG. 4. Comparative Example 1 corresponds to lamps disclosed in Patent Document 1, whereas Comparative Example 2 corresponds to patent document 2. The metal halide lamps of Comparative Examples 1 and 2 are basically identical in structure to the metal halide lamp 1 according to the first embodiment. The differences are found in the electrode distance EL, the maximum inside diameter Dᵢ of the arc tube, the kinds and amounts of metal halides acting as luminescent materials, and the amount of mercury acting as buffer gas.

Each metal halide lamp of Comparative Example 1 is such that the rated power is 200 W, the distance EL between the electrodes measures 40.0 mm, the maximum inside diameter Dᵢ of the arc tube measures 5.0 mm, EL/Dᵢ=8.0. In addition, the arc tube is filled with 4.5 mg of cerium iodide, 9.0 mg of sodium iodide, and 1.0 mg of mercury.

Each metal halide lamp of Comparative Example 2 is such that the rated power is 200 W, the distance EL between the electrodes measures 40.0 mm, the maximum inside diameter Dᵢ of the arc tube measures 5.0 mm, EL/Dᵢ=8.0. In addition, the arc tube is filled with 4.5 mg of praseodymium iodide, 9.0 mg of sodium iodide, and 1.0 mg of mercury.

Each lamp prepared was operated on an electronic ballast described above at the rated power in horizontal position to measure the total luminous flux (lm), efficiency (lm/W), color temperature (K), Duv, and average color rendering index (CRI). The measurement results are shown in FIG. 5.

Note that the measurements of the total luminous flux (lm), efficiency (lm/W), color temperature (K), Duv, and average color rendering index (CRI) shown in FIG. 5 are averages of the respective measurements made on the five samples after 100 hors of lighting. The design value of color temperature is 4000 K.

Each lamp was operated by repeating cycles of 5.5 hours of ON and 0.5 hours of OFF. The “lighting hours” refer to the total time period during which the respective lamp was ON.

Generally, it is said that the desirable color characteristic for general illumination purposes is such that the average CRI is 65 or higher and Duv is +10 or lower. Thus, these figures are used as evaluation criteria. In addition, the evaluation criterion of the efficiency (lm/W) is 120 lm/W or higher, which is sufficiently higher than the efficiency of ceramic metal halide lamps currently on the market (indoor use lamps: 90 to 100 lm/W, for example, and outdoor use lamps: 110 to 115 lm/W, for example).

As is clear from FIG. 5, Example 1 exhibited the lamp efficiency of 126.4 lm/W, the color temperature of 3850 K, Duv of +1.2, and the average CRI of 65. Example 2 exhibited the lamp efficiency of 129.5 lm/W, the color temperature of 3927 K, Duv of +7.4, and the average CRI of 65. Example 3 exhibited the lamp efficiency of 126.9 lm/W, the color temperature of 4121 K, Duv of +6.8, and the average CRI of 70. Example 4 exhibited the lamp efficiency of 125.8 lm/W, the color temperature of 4098 K, Duv of +6.6, and the average CRI of 69. Example 5 exhibited the lamp efficiency of 131.0 lm /W, the color temperature of 4025 K, Duv of +6.2, and the average CRI of 68. Example 6 exhibited the lamp efficiency of 122.9 lm/W, the color temperature of 4075 K, Duv of +5.8, and the average CRI of 68.

In contrast, Comparative Example 1 exhibited the lamp efficiency of 147.7 lm/W, the color temperature of 4091 K, Duv of +20.3, and the average CRI of 63. Comparative Example 2 exhibited the lamp efficiency of 130.0 lm/W, the color temperature of 4018 K, Duv of +12.2, and the average CRI of 67.

As described above, Examples 1-6 achieved the quality better than the evaluation criteria mentioned above. More specifically, Examples 1-6 achieved the higher lamp efficiency, the described color temperature, and color characteristic suitable for general illumination purposes. Especially notable is the measurement results of Example 2 that is substantially identical in structure to Example 1, except for the kinds and amounts of metal halides and the amount of buffer gas. Despite that, Example 2 exhibited the lamp efficiency of 129.5 lm/W, which is 2.5% better than the lamp efficiency of Example 1 (126.4 lm/W).

Now, Comparative Examples are discussed. Comparative Examples 1 and 2 also exhibited high efficiency that is beyond the evaluation criterion and also exhibited the desired color temperature. However, some of the measurement results of Comparative Examples failed to satisfy the evaluation criteria mentioned above. Especially, neither Comparative Example achieved Duv satisfying the above criterion and the color characteristic suitable for general illumination purposes, i.e., neither emitted light of a desirable color (white light).

The reasons for such measurement results are considered as follows.

First of all, Examples 1-6 and Comparative Examples 1-2 all exhibited significantly high lamp efficiency. This is by virtue of the specific dimensions of the arc tube 6 satisfying the relationship EL/Dᵢ>4.0. More specifically, the arc tube 6 is in an elongated shape with a small inside diameter. In other words, since the arc tube 6 is designed to have a small inside diameter to satisfy the relationship EL/Dᵢ>4.0, self-absorption of sodium acting as a luminescent material is reduced. This leads to an increase in light emission in a wavelength region that contributes to luminous efficiency. In addition, the inner surface of the arc tube 6 is relatively closer to arc occurring during lamp operation, so that the temperature of the arc tube 6 elevates high. This leads to that the vapor pressure of luminescent materials increases.

Example 2 exhibited efficiency better than that of Example 1 despite the fact that Example 2 is identical in structure to Example 1 except the kinds and amounts of metal halides and the amount of buffer gas. This is considered to be because of the emission spectrum of praseodymium that falls within the visible region.

In addition, in the case of Examples 1-6, the emission spectrum of neodymium leads to a shift in emission color of the arc tube to be more bluish. Furthermore, the vapor pressure of luminescent materials increases so that luminous intensity of light emitted by neodymium increases. Since the intensity of light emitted by sodium and neodymium also increases, the color balance is appropriately maintained. As a result, Duv is notably smaller, so that white light suitable for general illumination purposes is obtained.

In the case of Comparative Examples 1 and 2, however, the luminous intensity of light emitted by praseodymium or cerium is strong. Thus, overall emission light of the arc tube 6 contains a higher balance of green component, which resulted in that Duv is larger.

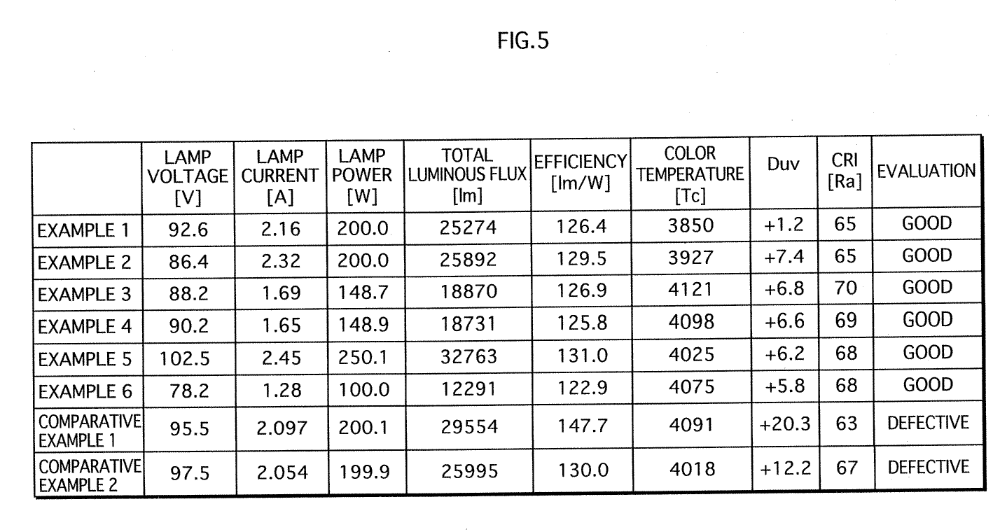

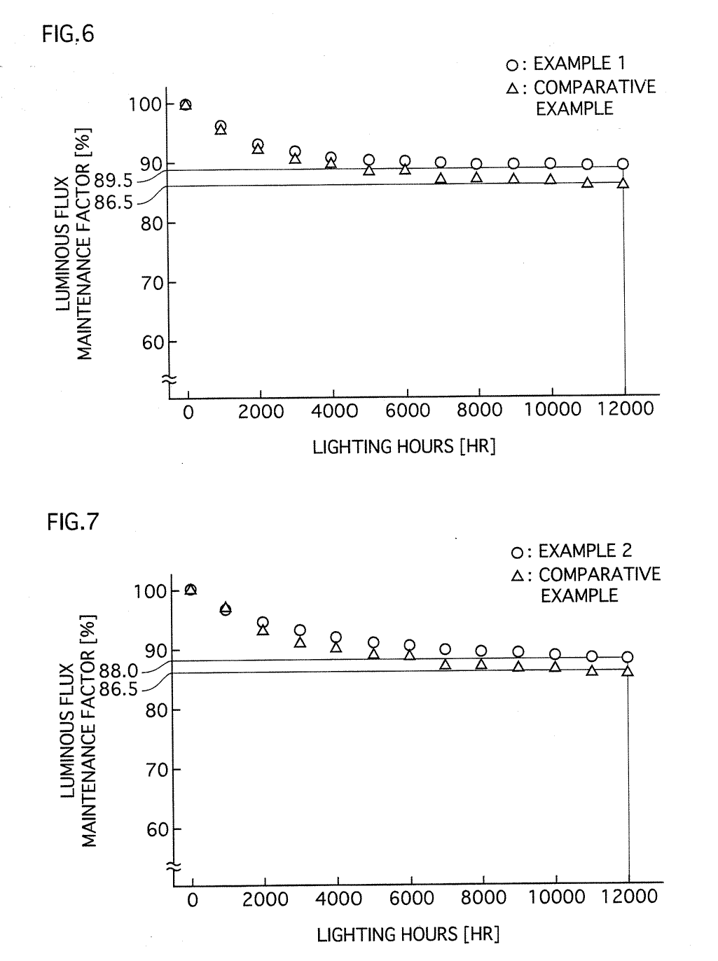

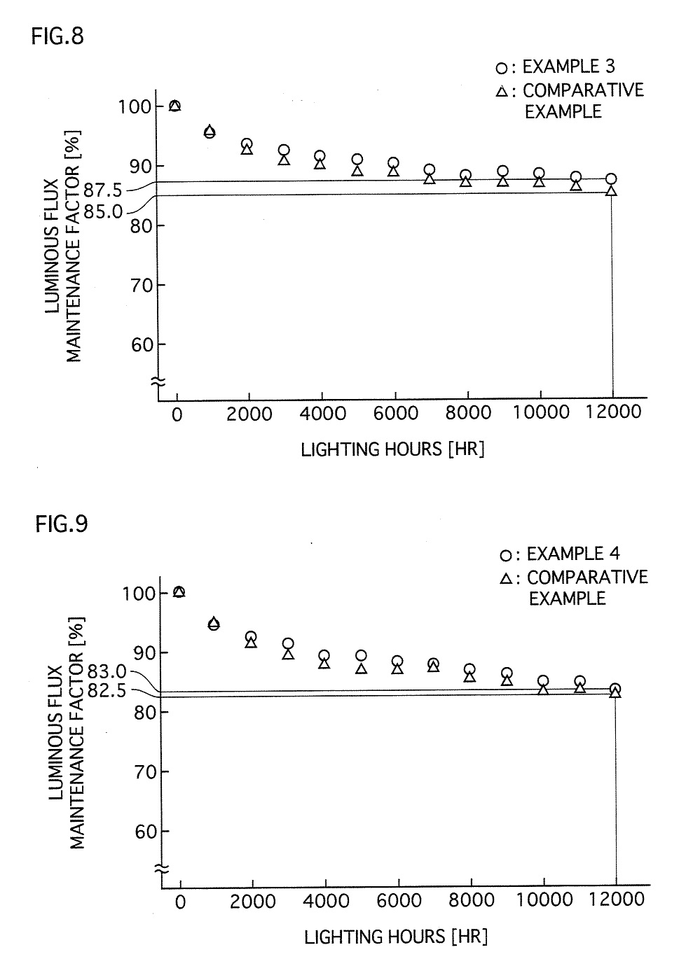

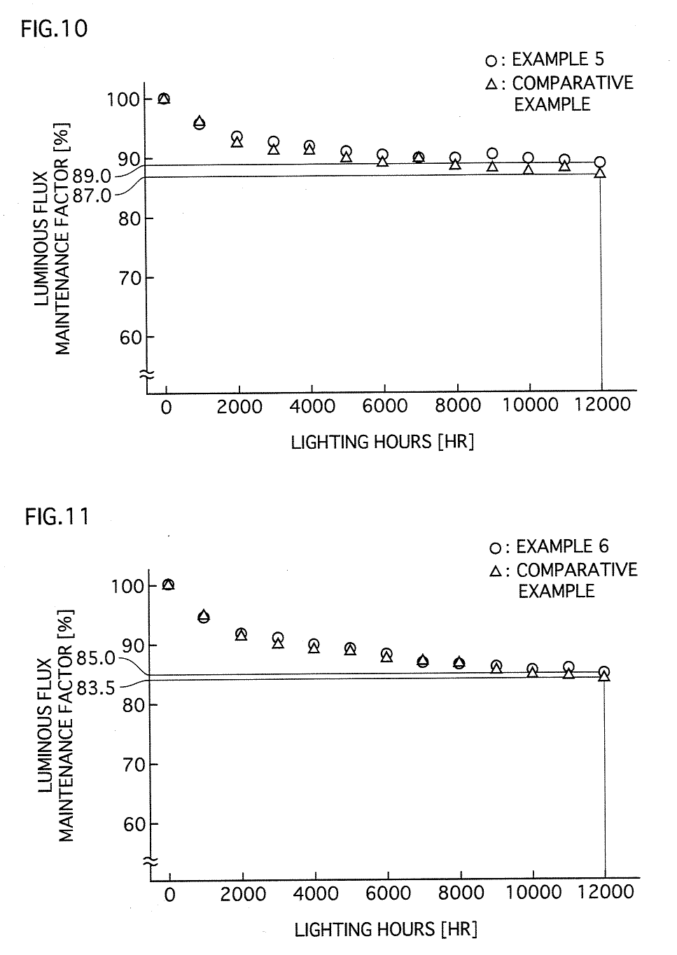

Here, Examples 1-6 were studied for their luminous flux maintenance factors (%) and compared with those of Comparative Example (i.e., conventional metal halide lamps of which sole difference with Examples 1-6 are found in the contents of metal halides). The comparison results are shown in FIGS. 6-11. More specifically, FIG. 6 shows the comparison of Example 1 with Comparative Example. FIG. 7 shows the comparison of Example 2 with Comparative Example. FIG. 8 shows the comparison of Example 3 with Comparative Example. FIG. 9 shows the comparison of Example 4 with Comparative Example. FIG. 10 shows the comparison of Example 5 with Comparative Example. FIG. 11 shows the comparison of Example 6 with Comparative Example.

Note that in FIGS. 6-11, the measurements on the respective Examples are indicated with the mark “o”, whereas the measurements on Comparative Example are indicated with the mark “Δ”. In addition, FIGS. 6-11 each show the luminous flux maintenance factor that are an average of the five samples of respective Examples. The “luminous flux maintenance factor” refers the percentage (%) of the total luminous flux (lm) measured during operation to the total luminous flux (lm) measured after 100 hours of operation.

As is apparent from FIG. 6, after e.g. 12000 hours of operation, the luminous flux maintenance factor of Example 1 is 89.5%, which is 3.5% higher than the luminous flux maintenance factor (86.5%) of Comparative Example. This proves that Example 1 is superior to conventional metal halide lamps in luminous flux maintenance factor.

As is apparent from FIG. 7, after e.g. 12000 hours of operation, the luminous flux maintenance factor of Example 2 is 88.0%, which is 1.7% higher than the luminous flux maintenance factor (86.5%) of Comparative Example. This proves that Example 2 is comparable or superior to conventional metal halide lamps in luminous flux maintenance factor.

As is apparent from FIG. 8, after e.g. 12000 hours of operation, the luminous flux maintenance factor of Example 3 is 87.5%, which is 2.9% better than the luminous flux maintenance factor (85.0%) of Comparative Example. This proves that Example 3 is comparable or superior to conventional metal halide lamps in luminous flux maintenance factor.

As is apparent from FIG. 9, after e.g.12000 hours of operation, the luminous flux maintenance factor of Example 4 is 83.0%, which is 0.6% better than the luminous flux maintenance factor (82.5%) of Comparative Example. This proves that Example 4 is comparable to metal halide lamps in luminous flux maintenance factor.

As is apparent from FIG. 10, after e.g. 12000 hours of operation, the luminous flux maintenance factor of Example 5 is 89.0%, which is 2.3% better than the luminous flux maintenance factor (87.0%) of Comparative Example. This proves that Example 5 is comparable or superior to conventional metal halide lamps in luminous flux maintenance factor.

As is apparent from FIG. 11, after e.g. 12000 hours of operation, the luminous flux maintenance factor of Example 6 is 85.0%, which is 1.8% better than the luminous flux maintenance factor (83.5%) of Comparative Example. This proves that Example 6 is comparable to conventional metal halide lamps in luminous flux maintenance factor.

As described above, Examples 1-6 are all superior or comparable to Comparative Example 1 in luminous flux maintenance factor. This is ascribable to the fact that Example 1-6 underwent relatively smaller reaction between neodymium and polycrystalline alumina. The former is a luminescent material and the latter is a construction material of the arc tube 6. As a result, neodymium was allowed to contribute light emission for an extended period.

On the other hand, Comparative Example underwent, during operation, cerium reacted with polycrystalline alumina relatively actively. The former is a luminescent material and the latter is a construction material of the arc tube 6. As a result, the amount of cerium, which would contribute to light emission, decreased as the lamp was operated.

In view of the above, it is concluded to be desirable that an arc tube satisfies the relationship EL/Dᵢ>4.0 and that metal halides enclosed within the arc tube include at least sodium iodide and neodymium iodide. With such an arc tube, the high lamp efficiency is maintained, Duv notably improves, which means that a desirable color characteristic for general illumination purposes is obtained. In addition, such an arc tube improves the luminance maintenance factor. Especially notable is that the addition of praseodymium iodide as one of the metal halides further improves the lamp efficiency.

Next, ten lamps of Example 1 and another ten lamps of Example 2 were prepared. Then, the lamps were operated on electronic ballasts as described above at the rated power and in a horizontal position. During 100 to 12000 hours of operation, the color temperature was measured on each lamp every 1000 hours. Each measurements of color temperature is compared against the color temperature measured after 100 hours of operation to obtain the color temperature differences (K). The results are shown below.

Note that the evaluation criterion of the color temperature difference is determined to be ±500 K, because such a level of difference is virtually not noticeable to human eye.

In the case of Example 1, on nine out of ten samples, the color temperature difference was maintained within ±500 K until 12000 hours of lamp operation. The remaining one sample exhibited the color temperature difference beyond ±500 K before the end of 12000 hours of lamp operation. In the case of Example 2, on the other hand, none of the ten samples exhibited the color temperature difference beyond ±500 K until 12000 hours of lamp operation.

As described above, although one of the samples of Example 1 exhibited the color temperature difference beyond 500 K, the results show Example 1 is without any problem to be put to practical use and relatively stable in color temperatures over a prolonged period of lamp operation. Especially, in the case of Example 2, all the samples never exhibited the color temperature difference beyond 500 K. The results show that Example 2 is significantly stable in color temperature over a prolonged period of time.

The results are ascribable to the following reason.

In the case where neodymium and sodium are enclosed as luminescent materials, changes in the color temperature depend upon the luminous intensity of neodymium, i.e., the vapor pressure of neodymium. During lamp operation, neodymium tends to partly condense on the inner surface of the arc tube 6 or within a limited space in the arc tube 6. The vapor pressure varies with the temperate of the condensed neodymium. For example, if the inner surface of the arc tube 6 blackens and thus the temperature within the arc tube 6 rises, the vapor pressure of neodymium increases and thus the color temperature rises.

On the other hand, in the case where praseodymium and sodium are enclosed as luminescent materials, the color temperature changes depending upon the luminous intensity of praseodymium, i.e., the vapor pressure of praseodymium. Part of praseodymium enclosed within the arc tube 6 is widespread in liquid phase and the vapor pressure of praseodymium hardly changes. Yet, the vapor pressure of praseodymium decreases as a result of reaction between praseodymium and polycrystalline alumina, which is a construction material of the arc tube 6. Thus, the color temperature decreases as well.

This is assumed to be the mechanism causing one sample of Example 1 to exhibit the color temperature difference beyond 500 K. In the case of Example 2, on the other hand, the tendency of higher color temperature due to the increase in vapor pressure of neodymium canceled out the tendency of lower color temperature due to the decrease in the vapor pressure of praseodymium. Because of the balance between the two tendencies, the color temperature was stabilized to fall within a desired range at all times.

As described above, it is found that the presence of to praseodymium iodide in addition to sodium iodide and neodymium iodide as metal halides serves to significantly stabilize the color temperature over a prolonged period.

Next, the following describes the reason why it is preferable that the maximum inside diameter Dᵢ (mm) of the arc tube 6 satisfies the relationship 3.0≦Dᵢ≦7.0.

When the maximum inside diameter Dᵢ (in mm) satisfies the relationship 3.0>Dᵢ, it means that the inner surface of the arc tube 6 is too close to arc. As a result, the arc tube 6 undergoes excessive temperature rise, which leads to generation of clacks due to thermal shock and the like at the time of ON and OFF cycle operation during testing. Alternatively, the lamp efficiency may decrease as a result that too much heat is lost from the tube wall. On the other hand, when the relationship Dᵢ>7.0 is satisfied, the curvature of arc occurring in such an arc tube tends to be large. Thus, the main tube 14 of the arc tube 6 undergoes a significant temperature rise at the top portion thereof. This results in a wider temperature difference between the top and bottom portions of the main tube 14 or the difference between the main and thin tubes 14 and 15. Due to such a wide temperature difference, the main tube 14 is apt to develop clacks.

Next, the following describes the reason why it is desirable that sodium halide and neodymium halide are enclosed as metal halides and that the relationship 5≦M_{Na}/M_{Nd}≦21 is satisfied. In this relationship, M_{Na} represents the amount of sodium halide in mol and M_{Nd} represents the amount of neodymium halide in mol.

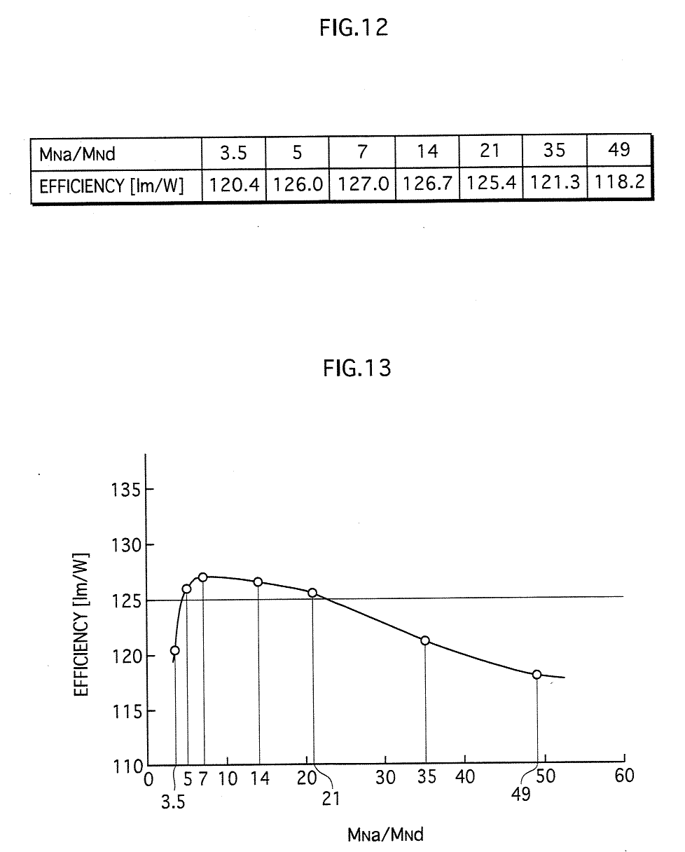

First of all, samples of Example 1 were prepared with different amounts of sodium iodide and neodymium iodide enclosed within the arc tube. More specifically, five samples were manufactured for each of the ratios M_{Na}/M_{Nd} shown in FIG. 12, all of which fall within the range of 3.5-49. Note that M_{Na} represents the amount of sodium iodide in mol and M_{Nd} represents the amount of neodymium iodide in mol. The sample lamps were then operated on the electronic ballasts described above at the rated power and in a horizontal position. After 100 hours of operation, the lamp efficiency (lm/W) of each lamp was measured. The measurement results are shown FIGS. 12 and 13.

Note that the lamp efficiencies shown in FIGS. 12 and 13 are an average of measurements obtained on the five samples.

As is apparent from FIGS. 12 and 13, as long as the relationship 5≦M_{Na}/M_{Nd}≦21 is satisfied, the resulting lamps all constantly exhibit a significantly high lamp efficiency exceeding 125 lm/W. This is ascribable to the synergistic effect between the highly efficient light emission resulting from restricted self-absorption of sodium and the emission of highly visible light by neodymium. That is, light emitted by sodium and neodymium is in balance and at wave lengths falling within a highly visual region.

On the other hand, when the relationship 5≦M_{Na}/M_{Nd}≦21 is not satisfied, the resulting lamp exhibits significantly lower lamp efficiency. When M_{Na}/M_{Nd}<5, especially when for example M_{Na}/M_{Nd}=3.5, light emission by sodium and neodymium is out of balance. That is, light emission by sodium dose not contribute much to improve the light efficiency and thus the resulting light efficiency is lower. When M_{Na}/M_{Nd}>21, especially when for example M_{Na}/M_{Nd}=35 or M_{Na}/M_{Nd}=49, light emission by sodium and neodymium is out of balance. That is, light emission by neodymium dose not contribute much to improve the light efficiency and thus the resulting light efficiency is lower.

Next, the following describes why it is preferable to satisfy the relationship 7≦M_{Na}/M_{Nd}. Note that M_{Na} represents the amount of sodium halide in mol, and M_{Nd} represents the amount of neodymium halide in mol.

The arc tube 6 chemically reacts more with neodymium halide as the ratio of neodymium halide to sodium halide is higher. As long as the relationship 7≦M_{Na}/M_{Nd} is satisfied, the chemical reaction would not cause a problem. However, when the relationship is not satisfied, there is a risk that the reaction between neodymium halide and the arc tube 6 would cause erosion of the arc tube 6 during the life test. The result would be occurrence of leak after 15000-20000 hours of lamp operation.

Next, the reason why it is preferable that the metal halides enclosed in an arc tube include sodium halide, neodymium halide, and praseodymium halide, and that the following relationship is satisfied:

4≦M_{Na}/(M_{Nd}+M_{Pr})≦27.5,
where M_{Pr}/M_{Nd}≦4, and
where M_{Na} represents the amount of sodium halide in mol,
M_{Nd} represents the amount of neodymium halide in mol, and
M_{Pr} represents the amount of praseodymium halide in mol.

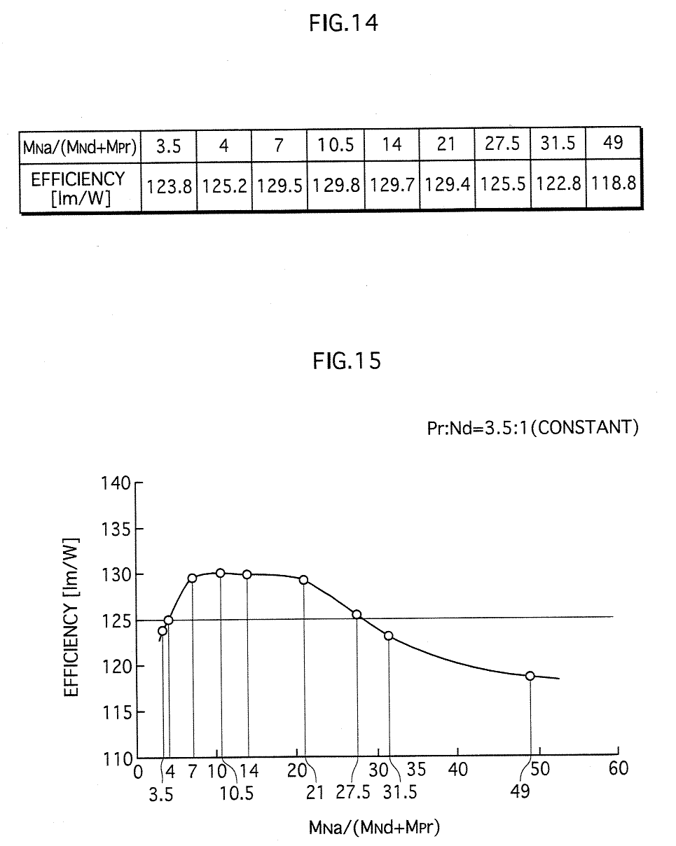

First of all, samples of Example 2 were prepared each with different amounts of sodium iodide, neodymium iodide, and praseodymium iodide enclosed within the arc tube. More specifically, five samples of Example 2 were prepared for each of the ratios M_{Na}/(M_{Nd}+M_{Pr}) shown in FIG. 14, all of which fall within the range of 3.5-49. Note that M_{Na} represents the amount of sodium iodide in mol, M_{Nd} represents the amount of neodymiium iodide in mol, and M_{Pr} represents the amount of praseodymium iodide in mol. Thus, M_{Na}/(M_{Nd}+M_{Pr}) represents the ratio between the total amount of neodymium iodide and praseodymium iodide (M_{Nd}+M_{Pr}) and the amount of sodium iodide. The samples were then operated on the electronic ballasts described above at a rated power and in a horizontal position. After 100 hours of operation, the lamp efficiency lm/W of each lamp was measured. The measurement results are shown FIGS. 14 and 15.

Note that each lamp efficiency shown in FIGS. 14 and 15 are an average of the five samples.

In addition, all the samples satisfy M_{Pr}/M_{Nd}=3.5.

As is apparent from FIGS. 14 and 15, as long as the relationship 4≦M_{Na}/(M_{Nd}+M_{Pr})≦27.5 is satisfied, the resulting lamp efficiency is significantly high and exceeds 125 lm/W. This is ascribable to the synergistic effect between the highly efficient light emission resulting from restricted self-adsorption of sodium and the emission of light by neodymium and praseodymium within a highly visible wavelength region. That is, light emitted by sodium, neodymium, and praseodymium is in balance and falls within a highly visible wavelength region. On the other hand, when M_{Na}/(M_{Nd}+M_{Pr})≦4, especially when for example M_{Na}/(M_{Nd}+M_{Pr})=3.5, light emission by the respective halides is out of balance. That is, light emission by sodium dose not contribute much to improve the light efficiency and thus the resulting lamp exhibits significantly lower lamp efficiency. The same holds in the case when M_{Na}/M_{Nd}>21, especially when for example M_{Na}/(M_{Nd+M}_{Pr})=31.5 or 49. In this case, too, the resulting lamp efficiency is lower because light emission is out of balance and light emission by neodymium and praseodymium does not contribute much to the lamp efficiency.

Next, the following describes the reason why it is preferable to satisfy the relationship 7≦M_{Na}/(M_{Nd}+M_{Pr}), where M_{Na} represents the amount of sodium halide in mol, M_{Nd} represents the amount of neodymium halide in mol, and M_{Pr} represents the amount of praseodymium halide in mol.

The arc tube 6 chemically reacts more with neodymium halide or praseodymium halide as the ratio of neodymium halide and praseodymium halide to sodium halide is higher. As long as the relationship 7≦M_{Na}/(M_{Nd}+M_{Pr}) is satisfied, the chemical reaction would not cause a problem. However, if the relationship is not satisfied, there is a risk that the reaction between neodymium halide and the arc tube 6 would cause erosion of the arc tube 6 during the life test. The result would be occurrence of leak after 15000-20000 hours of lamp operation.

Now, the following describes the reason why the arc tube is designed to satisfy the relationship M_{Pr}/M_{Nd}≦4. Normally, metal halides enclosed in the arc tube 6 do not fully evaporate during lamp operation. Rather, the metal halides are enclosed within the arc tube in such amounts that part of the metal halides remain in liquid or solid phase during lamp operation. In other words, the total amount of metal halides that can be enclosed at maximum is substantially limited. Thus, when adding praseodymium halide (blue-green emitting material) to sodium halide (red emitting material) and neodymium halide (blue emitting material), it is necessary to reduce M_{Nd}, which is the amount of neodymium halide, to obtain a desired color temperature. This is because praseodymium halide and neodymium halide emit light of a similar color.

That is, if M_{Pr} (=the amount of praseodymium halide), is increased too much, M_{Nd} (=the amount of neodymium halide) needs to be decreased too much. This results in Duv that is as large as Duv that would be obtained with a lamp containing no neodymium halide. In such a case, the presence of neodymium halide produces substantially no advantageous effect as described above. In view of this, when adding praseodymium halide, the relationship M_{Pr}/M_{Nd}≦4 needs to be satisfied to fully achieve the effect of neodymium halide.

In the above tests, M_{Pr}/M_{Nd}=3.5 is always true. Yet, it is confirmed that the same effect is achieved as long as M_{Pr}/M_{Nd} is equal to 4 or less (M_{Pr}/M_{Nd}≦4).

As described above, according to the first embodiment of the present invention, the metal halide lamp 1 having the above configuration is enabled to maintain high lamp efficiency, while especially improving Duv to achieve color characteristic suitable for the general illumination purposes. In addition, it is also ensured to improve the luminous flux maintenance factor.

Especially, with the addition of praseodymium iodide to the metal halides of sodium iodide and neodymium iodide, the lamp efficiency further improves and stably exhibits a color temperature that is extremely stable over long operation hours.

In the case where the metal halides enclosed in the arc tube include sodium iodide and neodymium iodide, it is preferable to satisfy the relationship 5≦M_{Na}/M_{Nd}≦21 to further improve the lamp efficiency. Note that M_{Na} represents the amount of sodium iodide in mol, and M_{Nd} represents the amount of neodymium iodide in mol.

In the case where the metal halides enclosed in the arc tube include sodium halide, neodymium halide, and praseodymium halide, it is preferable to satisfy the relationship 4≦M_{Na}/(M_{Nd}+M_{Pr})≦27.5 (where M_{Pr}/M_{Nd}≦4) to further improve the lamp efficiency. Note that M_{Na} represents the amount of sodium iodide in mol, M_{Nd} represents the amount of neodymium iodide in mol, and the M_{Pr} represents the amount of praseodymium iodide in mol.

The above embodiment describes the case where all the metal halides enclosed within the arc tube are iodides. It should be naturally appreciated, however, bromides or mixture of iodide and bromide may be used to achieve the same advantageous effect noted above.

The above embodiment describes that the envelope 10 is composed of the main tube 14 and the thin tubes 15 and that the main tube 14 is composed of the cylindrical portion 12 and the tapered portions 13. It should be naturally appreciated, however, that the description is given without limitation. For example, the envelope may have substantially dome-shaped ends instead of the tapered portions 13. More specifically, the envelope may be composed of a main tube and thin tubes, and the main tube may have a substantially tubular cylindrical portion and two hemisphere portions each of which substantially has the shape of a dome and joined at a respective one of the opposite ends of the cylindrical portion. Alternatively, the envelope may be composed of a main tube and thin tubes joined at the opposite ends of the main tube. The main tube may have a substantially tubular cylindrical portion and ring portions internally disposed at the opposite ends of the cylindrical portion. Each ring portion substantially has the shape of an annular ring. Each thin tube is in fit engagement with the inner periphery of a corresponding one of the ring portions. With such a modified envelope, the advantages effect noted above is still achieved.

In the case of former modification, the cylindrical portions and the thin tubes are integrally formed as a single piece. In the case of the latter modification, however, the cylindrical portion, ring portions, and the thin tubes are formed as separate pieces and joined into a single piece by shrinkage fit. Still further, all the embodiment and modifications above are each directed to the case where the envelope has a cylindrical portion having a substantially cylindrical shape. Alternatively, however, the cylindrical portion may instead be a portion having the shape of a spheroid of revolution or a spindle. In the case of a spindle, the envelope is diametrically largest at the central portion and gradually reduced in diameter toward the respective ends. Such an envelope still achieves the advantageous effect similar to that described above. In such a case, the central portion of the envelope has the maximum inside diameter Dᵢ.

The above embodiment is directed to the metal halide lamps 1 of which rated power (input power) are 100 W, 150 W, 200 W, and 250 W. Yet, these are mentioned merely by way of example and without limitation. For example, the present invention is applicable to metal halide lamps of which rated power (input power) fall within the range of 70-300 W.

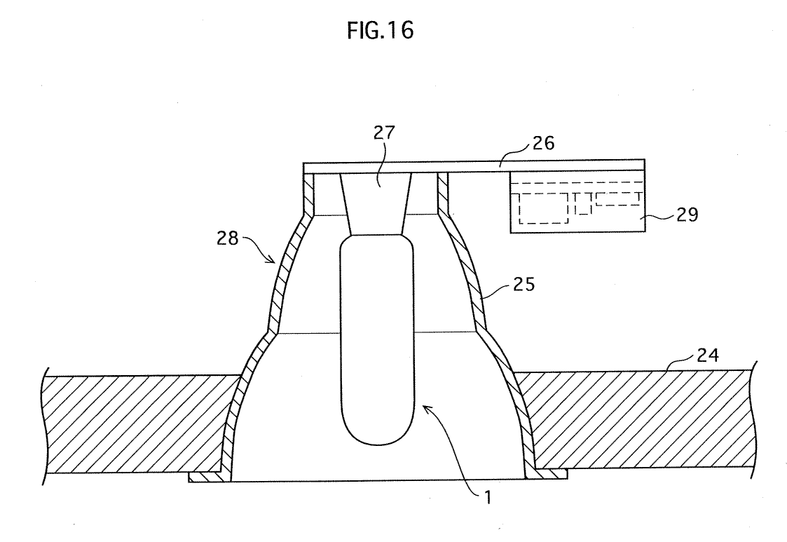

Next, the following describes a lighting unit according to a second embodiment of the present invention. The lighting unit is usable as a down light mounted, for example, in a ceiling as illustrated in FIG. 16. The lighting unit is composed of a lighting fixture 28, the metal halide lamp 1 according to the present invention, and an electronic ballast 29. The lighting fixture 28 includes an umbrella-shaped reflector 25 mounted in a ceiling 24, a plate like substrate part 26 externally attached to the bottom of the reflector 25, and a socket part 27 internally disposed on the bottom of the reflector 25. The metal halide lamp 1 is inserted into the socket part. The electronic ballast 29 is disposed to have a spaced relationship from the reflector 25 attached to the substrate part 26.

As has been described above, the lighting unit according to the second embodiment of the present invention employs the metal halide lamp 1 according to the first embodiment of the present invention. With this configuration, the lighting unit is ensured to achieve high lamp efficiency and emission color characteristics suitable for the general illumination purposes. In addition, it is also ensured to improve the luminous flux maintenance factor.

Although the second embodiment above describes a lighting unit used as a down ceiling light, the description is given merely by way of example and without limitation. The applications of lighting unit include other types of indoor illumination, outdoor illumination, and illumination for stores. In addition, the lighting unit may be used in conjunction with a suitable fixture and ballast known in the art.

### INDUSTRIAL APPLICABILITY

A lamp or lighting unit according to the present invention is usable in applications in which it is required to maintain high lamp efficiency, while improving the emission color characteristic.

1. A metal halide lamp comprising
an arc tube having:
a ceramic envelope;
a pair of electrodes; and
metal halides enclosed therein,
wherein the arc tube satisfies the relationship:
EL/Dᵢ>4.0, where
EL represents a distance between the pair of electrodes measured in millimeters, and
Dᵢ represents a maximum inside diameter of the arc tube measured in millimeters at a portion positionally corresponding to a gap between the pair of electrodes, and
wherein the metal halides include at least sodium halide and neodymium halide.

2. The metal halide lamp according to claim 1,
wherein the maximum inside diameter Dᵢ satisfies the relationship:
3.0≦Dᵢ≦7.0.

3. The metal halide lamp according to claim 1,
wherein the metal halides enclosed in the arc tube satisfy the relationship:
5≦M_{Na}/M_{Nd}≦21,
where
M_{Na} represents an enclosed amount of sodium halide in moles, and
M_{Nd} represents an enclosed amount of neodymium halide in moles.

4. The metal halide lamp according to claim 3,
wherein the metal halides enclosed in the arc tube satisfy the relationship:
7≦M_{Na}/M_{Nd}.

5. The metal halide lamp according to claim 1,
wherein the metal halides enclosed in the arc tube include praseodymium halide.

6. The metal halide lamp according to claim 4,
wherein the metal halides enclosed in the arc tube include praseodymium halide.

7. The metal halide lamp according to claim 5,
the metal halides enclosed in the arc tube satisfy the relationship:
4≦M_{Na}/(M_{Nd}+M_{Pr})≦27.5; and
M_{Pr}/M_{Nd}≦4,
where
M_{Pr} represents an enclosed amount of praseodymium halide.

8. The metal halide lamp according to claim 6,
wherein the metal halides enclosed in the arc tube satisfy the relationship:
4≦M_{Na}/(M_{Nd}+M_{Pr})≦27.5; and
M_{Pr}/M_{Nd}≦4,
where
M_{Pr} represents an enclosed amount of praseodymium halide.

9. The metal halide lamp according to claim 7,
wherein the metal halides enclosed in the arc tube satisfy the relationship:
7≦M_{Na}/(M_{Nd}+M_{Pr}).

10. The metal halide lamp according to claim 8,
wherein the metal halides enclosed in the arc tube satisfy the relationship:
7≦M_{Na}/(M_{Nd}+M_{Pr}).

11. A lighting unit comprising:
a metal halide lamp of claim 1;
a ballast for operating the metal halide lamp; and
a lighting fixture having the metal halide lamp incorporated therein.

12. A lighting unit comprising:
a metal halide lamp of claim 10;
a ballast for operating the metal halide lamp; and
a lighting fixture having the metal halide lamp incorporated therein.

13. The metal halide lamp according to claim 2,
wherein the metal halides enclosed in the arc tube satisfy the relationship:
5≦M_{Na}/M_{Nd}≦21,
where
M_{Na} represents an enclosed amount of sodium halide in moles, and
M_{Nd} represents an enclosed amount of neodymium halide in moles.
